(19) United States
(12) Patent Application Publication
(10) Pub. No.: US 2023/0401658 A1
(43) Pub. Date: Dec. 14, 2023

(54) PREDICTIVE METHOD FOR ANALYSING A MENU

(71) Applicant: MAIORA SOLUTIONS S.R.L., Monza (IT)

(72) Inventors: Andrea TORASSA, Torino (IT); Emilio ZUNINO, Genova (IT)

(21) Appl. No.: 18/252,120

(22) PCT Filed: Jun. 11, 2021
(86) PCT No.: PCT/IB2021/055141

§ 371 Date: May 8, 2023

(30) Foreign Application Priority Data
Nov. 10, 2020 (IT) 102020000026774

(51) Int. Cl. G06Q 50/12; G06Q 30/0202

(52) U.S. Cl. CPC G06Q 50/12; G06Q 30/0202

(57) ABSTRACT

A predictive method, implemented by a calculator, for analysing a menu is performed by acquiring a menu of a restaurant business comprising a plurality of potential items and a plurality of actual items.

The sales data of the restaurant business in at least one pre-set period of time and of the composition parameter associated with the potential items are also acquired.

A predictive statistical model is subsequently applied so as to predict a future sales volume for each actual item as a function of at least said sales data and for each potential item as a function of at least the respective composition parameter.

As a function of the future sales volumes, a saleability parameter is then determined for each actual and potential item which is used to identify whether an actual item is switchable to a potential item and vice versa.

The present invention relates to the technical field of methods and systems for data analysis related to a restaurant business.

In particular, the present invention relates to a predictive method for analysing a menu, such as the menu of a restaurant business.

The present invention also relates to a system capable of performing such a method.

Revenues and therefore the success of a commercial business are strongly influenced by the ability of the manager to identify the products which can be most requested by customers, while simultaneously applying an appropriate price.

However, both demand and willingness to pay a certain price can change over time, also fairly quickly.

In fact, it is known that certain products which can be sold by restaurant businesses are requested only at certain times of the year, or also that customers may be willing to pay higher prices in the periods of the year when certain products are most difficult to find.

Currently, the selection of products and the related prices of a menu is carried out solely on the basis of the experience of the restaurant business manager, therefore not using any scientific basis.

This procedure is therefore very approximate and its efficiency is strongly influenced by the individual skill of the manager.

Furthermore, in order to identify the products to be included/maintained within the menu, the manager must make continuous adjustments and assessments which require a considerable amount of time, subtracting it from other activities necessary for the management and proper functioning of the restaurant business.

Furthermore, the manager's analysis is inevitably focused solely on the specific sales point in which he operates and therefore any relevant information and also the experiential contributions of other sales points of the same restaurant business are lost.

Therefore, there is a strong need for new methods and systems capable of assisting the activity of composing a menu, both from the point of view of the products and the prices to be applied, such as to allow the optimisation, efficiency and acceleration of such an activity

In this context, the technical task underlying the present invention is to provide a predictive method for analysing a menu which overcomes at least some of the drawbacks in the prior art as described above.

In particular, an object of the present invention is to provide a predictive method for analysing a menu capable of assisting the managers of a restaurant business in the composition of a menu.

The stated technical task and the specified objects are substantially achieved by a predictive method for analysing a menu, comprising the technical features set forth in one or more of the appended claims.

According to the present invention, a predictive method, implemented by a calculator, for analysing a menu is shown.

The method is performed by acquiring a menu of a restaurant business.

In particular, the menu comprises a plurality of potential items that are representative of foods and/or beverages that the restaurant business can offer for sale and a plurality of actual items that are representative of foods and/or beverages that the restaurant business offers for sale.

The sales data of the restaurant business in at least one pre-set period of time are also acquired.

The sales data are representative of at least the sales volumes of each actual item.

At least one respective composition parameter is also associated with each potential item.

Each composition parameter is representative of a property of the potential item to which it is associated.

A predictive statistical model is then applied so as to predict a future sales volume for each actual item as a function of at least the sales data and for each potential item as a function of at least the respective composition parameter.

A saleability parameter of each actual and potential item is determined at least as a function of the respective future sales volume, identifying an actual item as switchable to a potential item and vice versa according to such a saleability parameter.

Advantageously, the method described here allows to automate and optimise the analysis process of a menu, putting the manager of a restaurant business in a position to immediately identify which products should be removed from the menu and which ones should be replaced.

Furthermore, the method described herein allows for a more detailed, synergistic and complete analysis by applying predictive algorithms which synergistically evaluate a large and varied amount of information which would not be processable by a human operator.

A system for analysing a menu is also presented.

The system comprises a database and at least one terminal connected thereto.

The computer is specifically configured to perform a method for analysing a menu, in particular a method for analysing a menu in accordance with the present invention.

The dependent claims, incorporated herein by reference, correspond to different embodiments of the invention.

Further features and advantages of the present invention will become more apparent from the approximate and thus non-limiting description of a preferred, but not exclusive, embodiment of a predictive method for analysing a menu.

According to a first aspect, the invention relates to a predictive method for analysing a menu actuatable by a calculator.

The term analysing generally refers to a process aimed at interpreting a wide range of information related to the products which a restaurant business is capable of providing for sale in order to identify which of such products have the greatest sales potential and whose introduction/maintenance within the list of products supplied for sale allow to maximise profits.

In particular, as will be discussed in more detail below, the method automates and optimises the restaurant business menu composition process by identifying which products should be actively shown and offered to customers and which ones can be removed from the offer provided to customers.

Operatively, the method is performed by acquiring a menu of a restaurant business.

Such a menu comprises a plurality of potential items that are representative of foods and/or beverages (indicated for conciseness below with the generic term products) which the restaurant business can offer for sale and a plurality of actual items that are representative of products that the restaurant business actually offers for sale.

In other words, the actual items represent those products that the restaurant business proposes for sale and that customers can view and buy.

The potential items, on the other hand, represent those products that the restaurant business is potentially able to produce but that it is not offering for sale to its customers at a given time.

For example, a potential item can identify a product that the restaurant business is able to produce because it possesses both the necessary equipment and skills, but for which at a given time (for example for reasons of seasonality) the raw ingredients necessary for its production are missing.

Potential items can also comprise products that are no longer offered for sale to customers because they had unsatisfactory sales volumes and/or excessive production costs.

Together with the menu, the sales data of the restaurant business are also acquired.

Such sales data represent at least the sales volumes of each actual item.

In other words, the sales volumes are collected by the restaurant business according to the products that are sold and indicate how many units of a given product have been purchased by the customers of the restaurant business.

In particular, the sales data acquired are limited to a given time period that can be selected by the restaurant business manager depending on the amount of data to be analysed.

For example, the time period can be one week, one month, or a longer or shorter period and can be changed over time as needed.

Still for example, the analysis can be performed several times independently to consider periods of time which differ not only in duration but also by type of period analysed: periods in which certain holidays, weekends, summer period, periods of partial closure of the commercial business or others are present.

Together with the sales data that provide information about the actual items, the method is performed by associating with each potential item at least one respective composition parameter representative of one of its properties.

In particular, the composition parameter is a parameter that represents product features which are useful for assessing the potential success that such a product would have if it were offered for sale to customers.

For example, the composition parameter can comprise at least one of: cost of the ingredients necessary for producing the potential item, seasonality of ingredients necessary for producing the potential item, acceptable price range for the potential item, seasonality of the potential item, presence in a warehouse of the ingredients necessary to create the potential item, satisfaction index and perceived value regarding the potential item, measured through quantitative market research subjected to a statistically representative panel of the customers which the restaurant addresses, possibility of combining the potential item with the actual menu items, also through special offers and promotions.

Furthermore, for those potential items representing products that the restaurant business has already proposed in past moments to customers, the composition parameter can advantageously also comprise the sales volumes that this product had when it was proposed to customers.

Furthermore, it is also possible to associate with each item a respective composition parameter which has the same features described for the composition parameters associated with the potential items.

In this context, the composition parameter of an actual item is considered an integral part of the sales data of the actual item.

In other words, according to such an aspect, the sales data comprise at least the sales volumes of the actual item and the composition parameter associated with such an actual item.

Therefore, in general, the method collects information that substantially represents the saleability of each product that the restaurant business proposes or is able to offer for sale.

Such information is processed by applying a predictive statistical model such as to predict a future sales volume for each actual item as a function of at least the sales data and for each potential item as a function of at least the respective composition parameter.

In other words, the history of the information collected by the restaurant business for each of the products which it is capable of selling is processed by a predictive statistical algorithm which allows to predict the future sales volumes of a given product and therefore how much such a product is potentially capable of contributing to improving the turnover and profit of the business.

In particular, the predictive statistical model is an autoregressive integrated moving average model.

The future sales volume generated for each item (actual and potential) is used to determine a saleability parameter of each actual and potential item, which in turn is processed to identify an actual item as switchable to a potential item and vice versa.

In other words, the method is performed by processing a plurality of information to determine a saleability parameter that effectively indicates the sales potential and the contribution to the turnover of the restaurant business of each actual and potential item and determines as a function of such an analysis which actual items should be removed from the offer presented to customers (thus switched to potential items) and which potential items instead have good saleability prospects at that time and should be inserted in the offer provided to customers (thus switched to actual items).

The actual switching can be delegated to the manager so as to allow for a final assessment which also benefits from the manager's experience.

Alternatively, the method can also comprise a switching step in which each actual item and each potential item identified as switchable is switched.

Thereby the automation of the analysis process is implemented at an even higher level, in fact determining a method for the composition of the menu of the restaurant business according to which the generation of a sales list comprising all the actual items to be presented to a customer is automatically and autonomously managed by the calculator.

Such an aspect can be applied at a general level or activated only at the same time as specific contingent situations.

For example, the switching of items from actual to potential could be enabled to be performed autonomously and automatically only if the identification of an item as switchable is directly due to the depletion of warehouse stock of the ingredients necessary to make such an actual item.

Thereby the operations which lead to the composition of the menu into multiple categories is divided, separating those for which it may be advantageous to introduce as a decision-making variable also the experiential factor from those for which this factor is not necessary (for example the aforementioned depletion of raw ingredients).

In general, the identification of an actual or potential item as switchable can be carried out by comparing the saleability parameter with a reference default value.

In this context, a saleability parameter below the threshold can determine that an actual item is identified as switchable or that a potential item remains so.

Similarly, a saleability parameter above the threshold can determine that a potential item is identified as switchable or that an actual item remains as such.

Alternatively or additionally, the determination of the switchability of a potential or actual item can be carried out by comparing a trend of the respective saleability parameter with a reference trend.

In general, future sales volumes are the main component for determining the saleability parameter, but not the only one.

For example, also a significant negative decrease in sales forecasts for an actual item with a high profit margin may be tolerable, while at the same time a modest decrease in sales forecasts for an actual item with a limited profit margin may lead to the identification of such an actual item as switchable.

In this context, the saleability parameter is determined as a function of both the future sales forecast and a profit margin of the product.

Other possible determining factors for the determination of the saleability parameter of an item, therefore for the identification of an actual or potential item as switchable, will be indicated below.

To allow a more contextual and accurate analysis of menu items, the method is performed by aggregating actual and potential items according to at least one aggregation criterion so as to define a plurality of groups of aggregated items.

Each group of aggregated items therefore comprises therein a list of actual and/or potential items which are common to each other by the aggregation criterion.

In this context, the application of the predictive statistical model is performed by applying the predictive statistical model to each group of items aggregated individually and independently.

In other words, the predictive algorithm is applied to each group, so that the saleability of each product is evaluated and compared only in relation to the saleability of products that have the same features determined by the aggregation criterion applied.

Preferably, the at least one aggregation criterion comprises at least one of: course of the actual item, day of the week identified as weekend or business and time slots during which the products can be dispensed, manner of consumption, i.e., if sold as take away or consumed at the table, method of sale of the product, i.e. if sold individually or as a component of a predefined menu and/or at full price or through a promotion.

For example, a group of aggregate items could therefore comprise all the products identifiable as appetisers or as beverages or as desserts.

It is thereby possible to make the analysis more accurate, since a given product can have an insufficient saleability parameter when compared, for example, with the standard sales volumes of the restaurant business, but still be high for the respective group to which it belongs.

For example, the sales volume of a particular liqueur could be so low that it could be interpreted as insufficient with respect to those of any course of a meal, but high if considered only with reference to the sales volumes of products belonging to the group of spirits, which can be determined by an aggregation criterion which identifies the products with an alcohol content above a certain threshold.

Therefore, in general, the step of applying a predictive statistical model, the step of determining a saleability parameter of each actual and potential item and the step of identifying an actual item as switchable to a potential item and vice versa are performed individually and independently for each group of aggregated items.

According to an aspect of the present invention, the acquisition of the menu of the restaurant business is carried out also acquiring the prices of each actual item and optionally also the prices associated with the potential items which had been identified as actual items in the past.

In other words, the method also acquires information related to the price which is applied to each product that the restaurant business has ever offered for sale to customers.

In this context, the method also calculates a price elasticity at least for each actual item based on sales data and the price associated therewith.

The expression price elasticity means, in the sense commonly associated thereto, the change in the quantity of a specific product requested by customers as a function of the price changes applied thereto.

In other words, price elasticity allows to quantify how much the demand for a product will be affected by the change in the price applied thereto.

As a function of the respective price elasticity, an optimal price is determined for each actual item in order to maximise the sales profit thereof.

The procedure explicitly identified above with reference to the actual items can also be advantageously performed for each potential item of which at least the price and sales data generated in a previous period in which such a specific potential item was an actual item are known.

Preferably, the determination of the optimal price is also performed as a function of at least one predefined constraint parameter.

Such a predefined constraint parameter can comprise at least one of: cost of the ingredients necessary for producing the actual item, price associated with the actual item in further restaurant businesses, market analysis, maximum price limit defined by the competitive approach adopted by the restaurant, which may therefore decide not to exceed the price that competitors apply to similar products or not to fall below a specific price in order not to deteriorate its brand position.

According to a further aspect of the present invention, the method is performed by generating for each actual item a plurality of couplings in which said actual item is combined with at least one different additional actual item.

In this context, the sales data are processed so as to generate a compatibility indicator for each coupling of actual items.

In particular, the compatibility indicator is generated as a function of the sales volume of such a coupling in the pre-set time period.

In other words, the compatibility indicator indicates how many times the coupling has been sold, i.e., how many times a customer has ordered both of the actual items which form such a coupling.

It is thereby possible to identify possible synergies between the actual items which are offered for sale to customers.

Advantageously, the saleability parameter can also be determined as a function of the compatibility indicator.

For example, a single actual item could present unsatisfactory future sales prospects, but the compatibility indicator could identify that such an actual item promotes the sale of a further actual item to such an extent that the poor sales prospects thereof are acceptable.

In this case, analysing the saleability parameter of such an item does not lead to the identification of the actual item in question as switchable, since the removal thereof from the products offered for sale to customers would also have a significant and unacceptable negative effect on the sales of a different actual item.

Furthermore, whenever an actual item is selected a signal is also generated which is adapted to identify each further actual item whose coupling with the actual item has a compatibility indicator that is greater than a reference value.

In other words, whenever a customer requests a certain actual item within an order, the method is performed so as to generate a signal which identifies, lists and proposes any other actual item that has a high (above the reference value) compatibility indicator with the actual item requested by the customer.

Therefore, if the analysis of sales volumes shows that certain couplings have high sales volumes, whenever a customer orders one of the products that are part of the coupling, it will be possible to offer the other product of the coupling for sale, improving service customisation and customer satisfaction.

Such an analysis can also be carried out on a percentage basis.

In other words, the compatibility indicator can be generated by determining a percentage value representative of how often a given actual item is selected by a customer as a function of the selection of another actual item.

Such a value therefore effectively represents the percentage probability that a customer is interested in selecting a given further actual item together with an actual item that they have already selected.

The method presented here is particularly efficient and useful when used by restaurant businesses which have a plurality of distinct sales points.

In fact, the analysis can be performed in this context, acquiring a greater volume and variety of information.

In particular, when there are multiple sales points, the acquisition of the menu and all the information and data related to the potential items and the actual items contained therein concerns the overall menu of the entire restaurant business (increasing the variety of data) and the data provided and collected at each individual sales point (increasing the volume of data).

Furthermore, the application of the predictive statistical model is performed so as to predict a future sales volume for each actual item also as a function of at least one property representative of at least one sales point.

It is thereby possible to customise the menu analysis according to the specificities that characterise each individual sales point.

By way of example, the features of the sales points that can be considered for the purposes of the analysis can comprise at least one of: geographic position of the sales point, dimensions of the sales point, average number of customers in the pre-set period of time, level of competitive concentration in the geographic area in which the sales point is located (i.e., number and type of competitors in the area), potential market in the area served by the sales point, i.e., flows of people and passage in the different hours of the day on the different days of the week, presence of commercial and social activities that provide services and/or complementary products with respect to the sales point, such as cinemas, theatres, shopping centres, stadiums, etc., type of geographic area based on the main economic activities (i.e., if office area and therefore with a large potential market during the lunch break on weekdays or if a shopping area, etc.).

Preferably, in this context the identification of an actual or potential item as switchable is performed autonomously and independently in each sales point.

Thereby, while having access to the information of each sales point, the method allows to analyse and optimise the menu of a sales point taking into account its specificities and without identically applying the modification indications applied at the other sales points which may not be optimal in the specific context.

The method described herein can be implemented by one or more calculators connected to a database within which data of interest for analysis is collected.

In particular, in accordance with the present invention, a system is further presented for analysing a menu comprising a database and at least one calculator.

In particular, the database is configured to store a menu of a restaurant business.

As described above, such a menu comprises a plurality of potential items that are representative of foods and/or beverages that the restaurant business can offer for sale and a plurality of actual items that are representative of foods and/or beverages that the restaurant business offers for sale.

The database further comprises the sales data on the restaurant business that are representative at least of sales volumes of each actual item.

In more detail, the database can comprise any other type of information, parameter, indicator, reference value presented and discussed in the present description and the use of which may be useful or necessary for analysing the menu.

The system then comprises a calculator connected to the database and configured to perform a method for analysing the menu contained in the database following one or more of the steps and procedural passages described.

In accordance with an aspect of the present invention, the system comprises a plurality of calculators, each associated with a distinct sales point of the restaurant business.

Each calculator can be further connected with one or more terminals usable for acquiring customer orders of the restaurant business, in order to acquire the information necessary for the performance of the analysis method in real time.

Therefore, the method, or in any case even only some specific steps thereof, can be performed in real time.

In particular, the system can generate the compatibility signal in real time, so that as soon as a customer decides to buy a product it is possible to immediately provide advice on a further product which can be combined with the first, for example by displaying such advice on the terminal.

Alternatively, all the information related to the sales data acquired through the terminals can be collected by the calculator and sent to the database for storage at regular intervals, for example at a specific time during the day.

Advantageously, the present invention achieves the proposed objectives by overcoming the drawbacks lamented in the prior art, providing the user with a method and a system for analysing a menu of a restaurant business which automates and makes analysing the individual products that are offered for sale more efficient, allowing to identify which products should be removed and which to introduce to optimise the operation of the restaurant business.

1. A predictive method, implemented by a calculator, for analysing a menu comprising the steps of:
acquiring a menu of a restaurant business, said menu comprising a plurality of potential items that are representative of foods and/or beverages that the restaurant business can offer for sale and a plurality of actual items that are representative of foods and/or beverages that the restaurant business offers for sale;
acquiring in at least one pre-set period of time sales data on the restaurant business that are representative at least of sales volumes of each actual item;
associating with each potential item at least one respective composition parameter that is representative of a property of said potential item;
applying a predictive statistical model so as to predict a future sales volume for each actual item as a function of at least said sales data and for each potential item as a function at least of the respective composition parameter;
determining a saleability parameter of each actual and potential item at least as a function of the respective future sales volume;
identifying an actual item as switchable to a potential item and vice versa as a function of the respective saleability parameter.

2. The method according to claim 1, comprising the step of switching each actual item and each potential item identified as switchable.

3. The method according to claim 1, wherein said at least one composition parameter comprises at least one of: cost of the ingredients necessary for producing the potential item, seasonality of the ingredients necessary for producing the potential item, acceptable price range for the potential item, seasonality of the potential item, approval rating and perceived value of the potential item.

4. The method according to claim 1, wherein the predictive statistical model is an autoregressive integrated moving average model.

5. The method according to claim 1, comprising a step of aggregating the actual items and the potential items according to at least one aggregation criterion so as to define a plurality of groups of aggregated items comprising respective actual items and potential items, preferably said at least one aggregation criterion comprising at least one of: course of the actual item or potential item, day of the week and/or time slots of the day during which the potential item or the actual item can be dispensed, manner of consumption, method of sale.

6. The method according to claim 5, wherein the step of applying a predictive statistical model, the step of determining a saleability parameter of each actual and potential item and the step of identifying an actual item as switchable to a potential item and vice versa are performed individually and independently for each group of aggregated items.

7. The method according to claim 1, wherein the step of acquiring a menu of the restaurant business is performed by further acquiring a plurality of prices, each price being associated with a respective actual item, said method comprising the steps of:
calculating a price elasticity for each actual item as a function of at least the sales data and the price associated with said actual item;
determining an optimal price for each actual item so as to maximize a sales profit of said actual item as a function of the respective price elasticity.

8. The method according to claim 7 wherein the step of determining an optimal price is performed as a function also of at least one predefined constraint parameter, preferably said predefined constraint parameter comprising at least one of: cost of the ingredients necessary for producing the actual item, price associated with the actual item in further restaurant businesses, market analysis, maximum and/or minimum price limit of the actual item.

9. The method according to claim 1 comprising the steps of:
generating for each actual item a plurality of couplings wherein said actual item is combined with at least one different actual item;
processing the sales data generating for each coupling a compatibility indicator that is representative of the sales volume of said coupling.

10. The method according to claim 9, wherein said saleability parameter is determined as a function also of said compatibility indicator

11. The method according to claim 9, wherein whenever an actual item is selected a compatibility signal is generated that is adapted to identify each further actual item whose coupling with the actual item has a compatibility indicator that is greater than a reference value.

12. The method according to claim 1, wherein the restaurant business comprises a plurality of distinct sales points and said step of applying a predictive statistical model is performed so as to predict a future sales volume for each actual item also as a function of at least one property that is representative of at least one sales point, preferably said representative property comprising at least one of: geographic position of the sales point, dimensions of the sales point, average number of customers in the predefined period of time, level of competitive concentration in the geographic area in which the sales point is located, potential market in the area served by the sales point, presence of commercial and social activities that provide services and/or complementary products with respect to the sales point.

13. The method according to claim 12, wherein the step of identifying an actual item as being switchable to a potential item and vice versa is performed autonomously and independently in each sales point.

14. A system for analysing a menu comprising:
a database configured to store a menu of a restaurant business, said menu comprising a plurality of potential items that are representative of foods and/or beverages that the restaurant business can offer for sale and a plurality of actual items that are representative of foods and/or beverages that the restaurant business offers for sale and sales data of the restaurant business that are representative at least of sales volumes of each actual item;
a calculator connected to the database and configured to implement a method to analyse a menu according to claim 1.

15. The system according to claim 14 comprising a plurality of calculators, each calculator being associated with a distinct sales point of the restaurant business.
